(19) United States
(12) Patent Application Publication
(10) Pub. No.: US 2020/0338989 A1
(43) Pub. Date: Oct. 29, 2020

(54) BATTERY CONTROL METHOD, BATTERY CONTROL SYSTEM, UNMANNED AERIAL VEHICLE, AND BATTERY

(71) Applicant: SZ DJI TECHNOLOGY CO., LTD., Shenzhen (CN)

(72) Inventor: Caihui ZHANG, Shenzhen (CN)

(21) Appl. No.: 16/927,566

(22) Filed: Jul. 13, 2020

Related U.S. Application Data
(63) Continuation of application No. PCT/CN2018/073326, filed on Jan. 19, 2018.

(51) Int. Cl. B60L 3/00; B64C 39/02; B64D 27/24; B60L 50/60; B60L 58/12; H02J 7/00

(52) U.S. Cl. CPC B60L 3/0061; B64C 39/024; B64D 27/24; B60L 50/60; B60L 58/12; H02J 7/0047; B60L 2240/549; B64C 2201/042; B60L 2200/10; B64C 2201/027; B60L 2240/545; B60L 2240/547; H02J 7/0031

(57) ABSTRACT

A battery control method, a battery control system, an unmanned aerial vehicle, and a battery are provided in the present disclosure. The method includes acquiring status information of an unmanned aerial vehicle and electrical parameter information of a battery, where the battery is configured to supply power to the unmanned aerial vehicle. The method further includes determining whether the battery is abnormal according to the electrical parameter information of the battery. The method further includes, when the status information of the unmanned aerial vehicle indicates that the unmanned aerial vehicle is in a flight status and the battery is in an abnormal status, controlling the battery to continue supplying the power to the unmanned aerial vehicle.

### CROSS-REFERENCE TO RELATED APPLICATION

This application is a continuation of International Application No. PCT/CN2018/073326, filed Jan. 19, 2018, the entire content of which is incorporated herein by reference.

### TECHNICAL FIELD

The present disclosure relates to the field of unmanned aerial vehicle and, more particularly, to a battery control method, a battery control system, an unmanned aerial vehicle, and a battery.

### BACKGROUND

A battery, as a power source of an unmanned aerial vehicle, is an indispensable part of the unmanned aerial vehicle in the existing technology. However, if the battery fails during the flight of the unmanned aerial vehicle, the unmanned aerial vehicle may crash, which reduces the safety of the unmanned aerial vehicle.

### SUMMARY

In accordance with the disclosure, a battery control method is provided in the present disclosure. The method includes acquiring status information of an unmanned aerial vehicle and electrical parameter information of a battery, where the battery is configured to supply power to the unmanned aerial vehicle; determining whether the battery is abnormal according to the electrical parameter information of the battery; and when the status information of the unmanned aerial vehicle indicates that the unmanned aerial vehicle is in a flight status and the battery is in an abnormal status, controlling the battery to continue supplying the power to the unmanned aerial vehicle.

Also in accordance with the disclosure, a battery control method is provided in the present disclosure. The method includes detecting status information of a processor in the battery control system and controlling a switch of a power supply circuit connected to a battery according to the status information of the processor, where the battery is configured to supply power to a movable platform.

### BRIEF DESCRIPTION OF THE DRAWINGS

In order to more clearly illustrate technical solutions in embodiments of the present disclosure, drawings required for describing the embodiments are briefly illustrated hereinafter. Obviously, the following drawings are merely examples for illustrative purposes according to various disclosed embodiments of the present disclosure and are not intended to limit the scope of the present disclosure. Those skilled in the art may obtain other drawings according to the drawings of the present disclosure without any creative efforts.

FIG. 1 illustrates a flow chart of a battery control method according to exemplary embodiments of the present disclosure;

FIG. 2 illustrates a structural schematic of an unmanned aerial vehicle according to exemplary embodiments of the present disclosure;

FIG. 3 illustrates a structural schematic of an unmanned aerial vehicle according to exemplary embodiments of the present disclosure;

FIG. 4 illustrates another flow chart of a battery control method according to exemplary embodiments of the present disclosure;

FIG. 5 illustrates a structural schematic of an unmanned aerial vehicle according to exemplary embodiments of the present disclosure;

FIG. 6 illustrates another flow chart of a battery control method according to exemplary embodiments of the present disclosure;

FIG. 7 illustrates another flow chart of a battery control method according to exemplary embodiments of the present disclosure;

FIG. 8 illustrates a structural schematic of a battery control system according to exemplary embodiments of the present disclosure;

FIG. 9 illustrates a structural schematic of an unmanned aerial vehicle according to exemplary embodiments of the present disclosure; and

FIG. 10 illustrates a structural schematic of a battery according to exemplary embodiments of the present disclosure.

### DETAILED DESCRIPTION OF THE EMBODIMENTS

The technical solutions in the embodiments of the present disclosure are clearly and completely described in the following with reference to the accompanying drawings in the embodiments of the present disclosure. It is obvious that the described embodiments are merely a part of the embodiments of the present disclosure, but not all embodiments. All other embodiments, based on the embodiments of the present disclosure, obtained by those skilled in the art without creative efforts are within the scope of the present disclosure.

It should be noted that when a component is called “fixed to” another component, it may be directly on another component or may have a centered component. When a component is considered to be “connected” to another component, it can be directly connected to another component or may have a centered component at the same time.

Unless defined otherwise, all technical and scientific terms used in the present disclosure may have the same meaning commonly understood by those skilled in the art. The terminology used in the specification of the present disclosure may be merely for the purpose of describing specific embodiments and may not be intended to limit the scope of the present disclosure. The term “and/or” as used in the present disclosure includes any and all combinations of one or more of the associated listed items.

Various embodiments of the present disclosure are described in detail with reference the drawings hereinafter. In the case of no conflict, the following embodiments and features of the embodiments may be combined with each other.

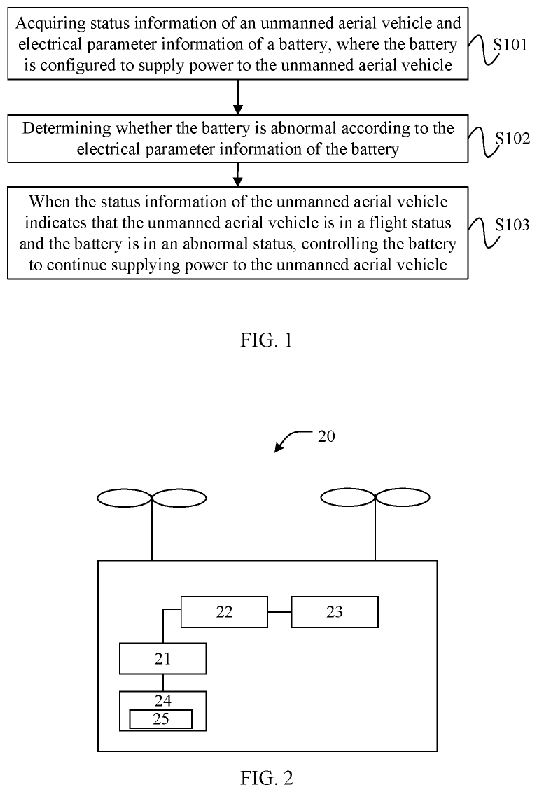

The embodiments of the present disclosure provide a battery control method. FIG. 1 illustrates a flow chart of the battery control method according to exemplary embodiments of the present disclosure. The battery control method provided in the embodiments of the present disclosure may be applied to a battery control system. As shown in FIG. 1, the method in the embodiments may include the following steps.

At step S101, the status information of an unmanned aerial vehicle and the electrical parameter information of a battery may be acquired, where the battery may be configured to supply power to the unmanned aerial vehicle.

In one embodiment, the battery control system may be configured to control the battery, and the battery may be configured to supply power to the unmanned aerial vehicle. The battery control system may be disposed in the unmanned aerial vehicle or in the housing of the battery.

As shown in FIG. 2, the unmanned aerial vehicle 20 may include a battery 21, a battery control system 22, and a flight controller 23. The battery 21 may be configured to supply power to the unmanned aerial vehicle 20. The battery control system 22 may include one or more processors which may be micro controller units (MCUs).

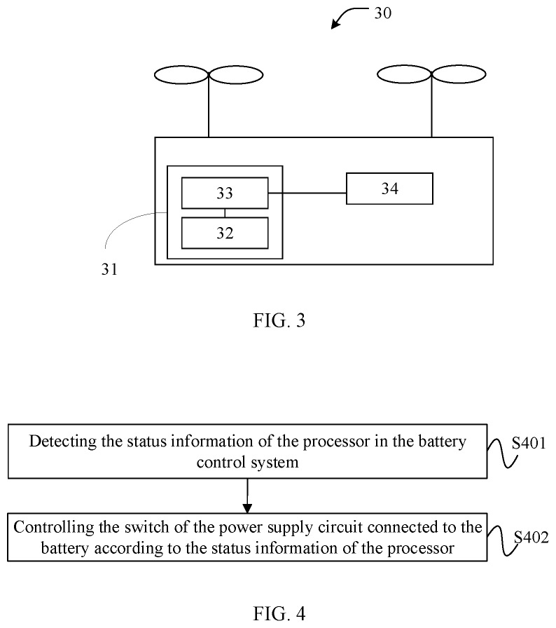

As shown in FIG. 3, an unmanned aerial vehicle 30 may include a battery 31 and a flight controller 34. The battery 31 may include a battery cell 32 and a battery control system 33. The battery 31 may be configured to supply power to the unmanned aerial vehicle 30, and the battery control system 33 may be respectively connected to each of the battery cell 32 and the flight controller 34.

The case shown in FIG. 2 is used as an example for illustrative description in one embodiment. As shown in FIG. 2, the battery control system 22 may acquire the status information of the unmanned aerial vehicle 20 and the electrical parameter information of the battery 21.

Acquiring the status information of the unmanned aerial vehicle may include receiving the status information of the unmanned aerial vehicle transmitted by the flight controller of the unmanned aerial vehicle. For example, the flight controller 23 may determine the status information of the unmanned aerial vehicle 20 according to the flight status parameters of the unmanned aerial vehicle 20; furthermore, the flight controller 23 may transmit the status information of the unmanned aerial vehicle 20 to the battery control system 22. After receiving the flight information of the unmanned aerial vehicle 20 transmitted by the flight controller 23, the battery control system 22 may determine whether the unmanned aerial vehicle 20 is in a flight status according to the status information of the unmanned aerial vehicle 20.

Moreover, the battery control system 22 may further include an electrical parameter detection circuit which may be configured to detect the electrical parameter information of the battery 21.

Optionally, the electrical parameter information of the battery may include at least one of the following: a voltage, a current, an output power, a remaining power, or a temperature of the battery.

At step S102, whether the battery is abnormal may be determined according to the electrical parameter information of the battery.

Optionally, a processor in the battery control system 22 may determine whether the battery 21 is abnormal according to the electrical parameter information of the battery 21. For example, it may determine whether the voltage of the battery 21 is less than a preset voltage value, whether the temperature of the battery 21 is greater than a preset temperature value, whether the current of the battery 21 is greater a preset current value, and whether the power of the battery 21 is greater than a rated power, and the like.

At step S103, when the status information of the unmanned aerial vehicle indicates that the unmanned aerial vehicle is in the flight status and the battery is in the abnormal status, the battery is controlled to continue supplying power to the unmanned aerial vehicle.

For example, when the battery control system 22 determines that the unmanned aerial vehicle 20 is in the flight status and the battery 21 is in the abnormal status, the battery control system 22 may control the battery 21 to continue supplying power to the unmanned aerial vehicle 20. It should be understood that when the battery control system 22 determines that the unmanned aerial vehicle 20 is in the flight status and the battery 21 is in the abnormal status, if the battery 21 does not continue supplying power to the unmanned aerial vehicle 20, the unmanned aerial vehicle 20 may crash and be damaged. The battery control system 22 controls the battery 21 to continue supplying power to the unmanned aerial vehicle 20, which may ensure that the unmanned aerial vehicle 20 does not immediately crash and be damaged. At this point, the battery control system 22 may transmit the abnormal status information of the battery 21 to the flight controller 23, and the flight controller 23 may control the unmanned aerial vehicle 20 to descend according to the abnormal status information of the battery 21.

For example, determining whether the battery is abnormal according to the electrical parameter information of the battery may include determining whether the battery is undervoltage according to the voltage of the battery.

If the battery control system 22 determines that the voltage of the battery 21 is less than the preset voltage value, the battery control system 22 may determine that the battery 21 is in an undervoltage status.

For example, when the status information of the unmanned aerial vehicle indicates that the unmanned aerial vehicle is in the flight status and the battery is in the abnormal status, the battery is controlled to continue supplying power to the unmanned aerial vehicle, which may include that when the status information of the unmanned aerial vehicle indicates that the unmanned aerial vehicle is in the flight status and the battery is in the undervoltage status, the battery is controlled to continue supplying power to the unmanned aerial vehicle.

For example, when the battery control system 22 determines that the unmanned aerial vehicle 20 is in the flight status and the battery 21 is in the undervoltage status, the battery control system 22 may control the battery 21 to continue supplying power to the unmanned aerial vehicle 20.

Optionally, controlling the battery to continue supplying power to the unmanned aerial vehicle may include controlling a power supply circuit connected to the battery to continue supplying power to the unmanned aerial vehicle.

As shown in FIG. 2, 24 denotes the power supply circuit connected to the battery 21, and the battery 21 may supply power to the unmanned aerial vehicle 20 through the power supply circuit 24. Optionally, one feasible implementation of the battery control system 22 to control the battery 21 to continue supplying power to the unmanned aerial vehicle 20 is that the battery control system 22 may control the power supply circuit 24 connected to the battery 21 to continue supplying power to the unmanned aerial vehicle 20.

Optionally, controlling the power supply circuit connected to the battery to continue supplying power to the unmanned aerial vehicle may include controlling the switch of the power supply circuit connected to the battery to be connected (e.g., closed), such that the power supply circuit may continue supplying power to the unmanned aerial vehicle.

As shown in FIG. 2, the power supply circuit 24 may include a switch 25. The switch 25 may be a metal oxide semiconductor (MOS) tube. Optionally, when the switch 25 is connected (e.g., closed), the battery 21 may supply power to the unmanned aerial vehicle 20 through the power supply circuit 24; and when the switch 25 is disconnected (e.g., open), the battery 21 may not supply power to the unmanned aerial vehicle 20 through the power supply circuit 24.

When the battery control system 22 determines that the unmanned aerial vehicle 20 is in the flight status and the battery 21 is in the undervoltage status, the battery control system 22 may, by controlling the switch 25 to be connected, make the battery 21 continue supplying power to the unmanned aerial vehicle 20 through the power supply circuit 24.

In other embodiments, the method may further include when the status information of the unmanned aerial vehicle indicates that the unmanned aerial vehicle is in the non-flight status and the battery is in the abnormal status, the battery is controlled to stop supplying power to the unmanned aerial vehicle.

As shown in FIG. 2, when the battery control system 22 determines that the unmanned aerial vehicle 20 is in the non-flight status (for example, copying data by the unmanned aerial vehicle 220), and when the battery control system 22 determines that the battery 21 is in the abnormal status, the battery control system 22 may control the battery 21 to stop supplying power to the unmanned aerial vehicle 20, thereby protecting the battery 21 from being damaged.

When the status information of the unmanned aerial vehicle indicates that the unmanned aerial vehicle is in the non-flight status and the battery is in the abnormal status, the battery is controlled to stop supplying power to the unmanned aerial vehicle, which may include that when the status information of the unmanned aerial vehicle indicates that the unmanned aerial vehicle is in the non-flight status and the battery is in the undervoltage status, the battery is controlled to stop supplying power to the unmanned aerial vehicle.

For example, if the battery control system 22 determines that the voltage of the battery 21 is less than the preset voltage value, the battery control system 22 may determine that the battery 21 is in the undervoltage status. When the battery control system 22 determines that the unmanned aerial vehicle 20 is in the non-flight status (e.g., copying data by the unmanned aerial vehicle 220), and when the battery control system 22 determines that the battery 21 is in the undervoltage status, the battery control system 22 may control the battery 21 to stop supplying power to the unmanned aerial vehicle 20, thereby preventing the battery 21 from being damaged in the undervoltage status.

Controlling the battery to stop supplying power to the unmanned aerial vehicle may include controlling the power supply circuit connected to the battery to stop supplying power to the unmanned aerial vehicle.

Optionally, one feasible implementation of the battery control system 22 to control the battery 21 to stop supplying power to the unmanned aerial vehicle 20 is that the battery control system 22 may control the power supply circuit 24 connected to the battery 21 to stop supplying power to the unmanned aerial vehicle 20.

Controlling the power supply circuit connected to the battery to stop supplying power to the unmanned aerial vehicle may include controlling the switch of the power supply circuit connected to the battery to be disconnected, such that the power supply circuit may stop supplying power to the unmanned aerial vehicle.

When the battery control system 22 determines that the unmanned aerial vehicle 20 is in the flight status and the battery 21 is in the undervoltage status, the battery control system 22 may, by controlling the switch 25 to be disconnected, make the power supply circuit 24 stop supplying power to the unmanned aerial vehicle 20.

Furthermore, the implementation manner and principle of the battery control system 33 shown in FIG. 3 may be same as the implementation manner and principle of the battery control system 22 shown in FIG. 2, which may not be described in detail herein.

In one embodiment, the status information of the unmanned aerial vehicle and the electrical parameter information of the battery may be acquired through the battery control system, and whether the battery is abnormal is determined according to the electrical parameter information of the battery. When the unmanned aerial vehicle is in the flight status and the battery is in the abnormal status, the battery control system may control the battery to continue supplying power to the unmanned aerial vehicle, thereby preventing the unmanned aerial vehicle from crashing due to battery interruption during the flight process to ensure the safety of the unmanned aerial vehicle.

The embodiments of the present disclosure may provide a battery control method. FIG. 4 illustrates another flow chart of a battery control method according to exemplary embodiments of the present disclosure. As shown in FIG. 4, the method in one embodiment may further include the following steps on the basis of the embodiments shown in FIG. 1.

At step S401, the status information of the processor in the battery control system may be detected.

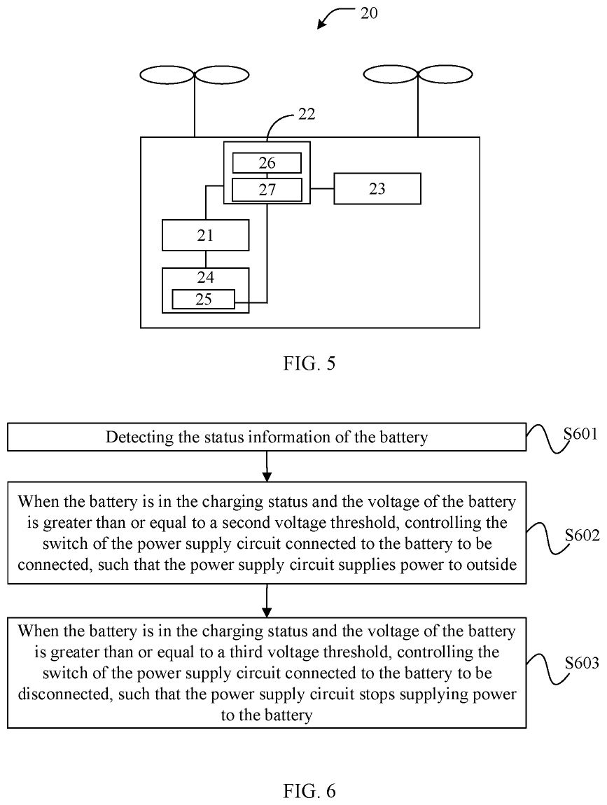

As shown in FIG. 5, the battery control system 22 may include a processor 26 and a driving circuit 27. The processor may include a micro controller unit (MCU), and the driving circuit 27 may be configured to control the switch 25 of the power supply circuit 24 connected to the battery 21.

Detecting the status information of the processor in the battery control system may include that the driving circuit in the battery control system detects whether the processor in the battery control system is abnormal. The driving circuit may be configured to control the switch of the power supply circuit connected to the battery.

Optionally, the driving circuit 27 in the battery control system 22 may detect whether the processor 26 is abnormal.

At step S402, the switch of the power supply circuit connected to the battery may be controlled according to the status information of the processor.

For example, the driving circuit 27 may control the switch 25 of the power supply circuit 24 connected to the battery 21 according to the status information of the processor 26.

For example, controlling the switch of the power supply circuit connected to the battery according to the status information of the processor may include that if the processor is in the abnormal status, the driving circuit may control the switch of the power supply circuit connected to the battery to be connected, such that the power supply circuit may continue supplying power to the unmanned aerial vehicle.

For example, when the driving circuit 27 determines that the processor 26 is in the abnormal status, the driving circuit 27 may control the switch 25 of the power supply circuit 24 connected to the battery 21 to be connected, such that the power supply circuit 24 may continue supplying power to the unmanned aerial vehicle 20.

Detecting whether the processor in the battery control system is abnormal by the driving circuit in the battery control system may include detecting whether the processor in the battery control system is in a reset status by the driving circuit in the battery control system.

For example, the driving circuit 27 in the battery control system 22 may detect whether the processor 26 is in the reset status.

If the processor is in the abnormal status, the driving circuit may control the switch of the power supply circuit connected to the battery to be connected, such that the power supply circuit may continue supplying power to the unmanned aerial vehicle, which may include that if the processor is in the reset status, the driving circuit may control the switch of the power supply circuit connected to the battery to be connected, such that the power supply circuit may continue supplying power to the unmanned aerial vehicle.

For example, when the driving circuit 27 determines that the processor 26 is in the reset status, the driving circuit 27 may control the switch 25 of the power supply circuit 24 connected to the battery 21 to be connected. Therefore, the power supply circuit 24 may continue supplying power to the unmanned aerial vehicle 20, which may avoid that the unmanned aerial vehicle 20 in the flight status is forced to crash because the battery 21 may immediately stop supplying power to the unmanned aerial vehicle 20 when the reset of the processor 26 is interfered. In other embodiments, when the reset of the processor 26 is interfered, the flight controller 23 may not be able to communicate normally with the processor 26. At this point, the flight controller 23 may control the unmanned aerial vehicle 20 to descend to avoid crash.

Furthermore, controlling the switch of the power supply circuit connected to the battery according to the status information of the processor may include that when the processor is in an upgrade status and the current of the battery is greater than or equal to a current threshold, the switch of the power supply circuit connected to the battery may be controlled to be disconnected, such that the power supply circuit may stop supplying power.

The processor 26 may further detect other status information. For example, the processor 26 may further detect whether the processor is in the upgrade status. If the processor 26 is in the upgrade status, an upgrade loader may also detect the voltage and/or current of the battery 21. Furthermore, the processor 26 may also control the switch 25 of the power supply circuit 24 connected to the battery 21 according to the voltage and/or current of the battery 21.

For example, when the processor 26 is in the upgrade status and the current of the battery 21 is greater than or equal to the current threshold, the switch 25 of the power supply circuit 24 connected to the battery 21 may be controlled to be disconnected by the processor 26, such that the power supply circuit may stop supplying power and the battery 21 may be avoided to be damaged due to overcurrent.

Moreover, controlling the switch of the power supply circuit connected to the battery according to the status information of the processor may include that when the processor is in the upgrade status and the voltage of the battery is less than or equal to a voltage threshold, the switch of the power supply circuit connected to the battery may be controlled to be disconnected, such that the power supply circuit may stop supplying power.

For example, when the processor 26 is in the upgrade status and the voltage of the battery 21 is less than or equal to a first voltage threshold (i.e., undervoltage), the switch 25 of the power supply circuit 24 connected to the battery 21 may be controlled to be disconnected, such that the power supply circuit 24 may stop supplying power and the battery 21 may be avoided to be damaged due to undervoltage. Optionally, the first voltage threshold may be 3.2 V.

In other embodiments, the method may further include the following steps shown in FIG. 6.

At step S601, the status information of the battery may be detected.

As shown in FIG. 5, the processor 26 may also detect the status information of the battery 21. For example, when the voltage of the battery 21 is less than or equal to 3.2 V, the battery 21 may need to be charged. The processor 26 may detect whether the battery 21 is in a charging status.

Optionally, when the processor 26 is in the upgrade status, the battery 21 may supply power to outside; when the battery 21 is connected to the charger, the battery 21 may start to be charged without supply power to outside. In one embodiment, the battery may not only supply power to the unmanned aerial vehicle, but also supply power to other loads.

At step S602, when the battery is in the charging status and the voltage of the battery is greater than or equal to a second voltage threshold, the switch of the power supply circuit connected to the battery may be controlled to be connected, such that the power supply circuit may supply power to outside.

For example, when the processor 26 is in the upgrade status, the battery 21 may supply power to outside and the voltage of the battery 21 may continuously decrease. When the voltage of the battery 21 is less than or equal to 3.2V, the switch 25 of the power supply circuit 24 connected to the battery 21 may be controlled to be disconnected by the processor 26. At this point, the battery 21 may not supply power to outside, thereby preventing the battery 21 from being damaged.

When the battery 21 is in the charging status, the voltage of the battery 21 may continuously increase. When the voltage of the battery 21 is greater than or equal to the second voltage threshold (e.g., 3.2V), the switch 25 of the power supply circuit 24 connected to the battery 21 may be controlled to be connected by the processor 26. At this point, the battery 21 may supply power to outside.

At step S603, when the battery is in the charging status and the voltage of the battery is greater than or equal to a third voltage threshold, the switch of the power supply circuit connected to the battery may be controlled to be disconnected, such that the power supply circuit may stop supplying power to the battery.

When the battery 21 is in the charging status, the voltage of the battery 21 may continuously increase. When the voltage of the battery 21 is greater than or equal to the second voltage threshold (e.g., 3.2V), the switch 25 of the power supply circuit 24 connected to the battery 21 may be controlled to be connected by the processor 26. At this point, the battery 21 may supply power to outside. If the battery 21 continues to be charged at this point, the voltage of the battery 21 may continue to increase. When the voltage of the battery 21 is greater than or equal to the third voltage threshold, for example, 4.2V (i.e., the battery 21 is in the overvoltage status), the switch 25 of the power supply circuit 24 connected to the battery 21 may also be controlled to be disconnected by the processor 26. Since the battery 21 is connected to the charger through the charging circuit, when the switch of the charging circuit connected to the battery 21 is controlled to be disconnected by the processor 26, it is equivalent to that the connection between the battery 21 and the charger is controlled to be disconnected. In such way, the charger may stop charging the battery 21 continuously, thereby prevent excessively high voltage or temperature of the battery 21 during the charging process from affecting the performance of the battery 21.

In one embodiment, by detecting the status information of the processor in the battery control system, the switch of the power supply circuit connected to the battery may be controlled according to the status information of the processor, which may avoid that the unmanned aerial vehicle in the flight status is forced to crash because the battery immediately may stop supplying power to the unmanned aerial vehicle when the reset of the processor is interfered. Moreover, when the processor is in the upgrade status and the battery is in a undervoltage or overcurrent status, the switch of the power supply circuit connected to the battery may be controlled to be disconnected. Therefore, the power supply circuit may stop supplying power to prevent the battery from being damaged due to undervoltage or overcurrent, and on the basis of ensuring the safe flight of the unmanned aerial vehicle, the battery may be avoided to be damaged. Furthermore, by detecting the voltage of the battery during the charging process of the battery, when the battery is in the overvoltage status, the switch of the charging circuit connected to the battery may be controlled to be disconnected, such that the charging circuit may stop charging the battery to prevent the battery from being damaged due to overvoltage.

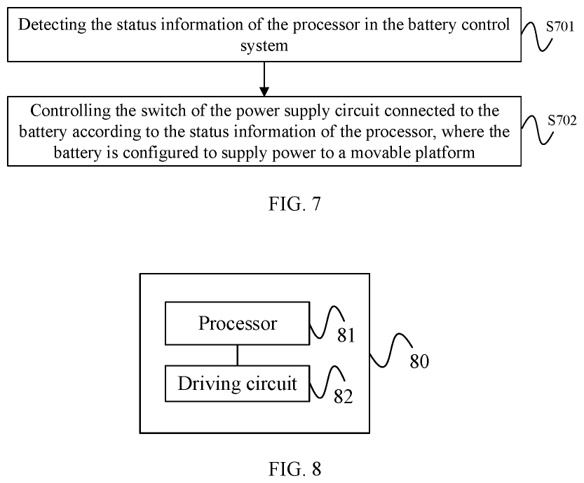

The embodiments of the present disclosure may provide a battery control method. FIG. 7 illustrates another flow chart of a battery control method according to exemplary embodiments of the present disclosure. As shown in FIG. 7, the battery control method in one embodiment may be applied to the battery control system. The method in one embodiment may include the following steps.

At step S701, the status information of the processor in the battery control system may be detected.

As shown in FIG. 5, the battery control system 22 may include the processor 26 and the driving circuit 27. The processor may include a micro controller unit (MCU), and the driving circuit 27 may be configured to control the switch 25 of the power supply circuit 24 connected to the battery 21.

Detecting the status information of the processor in the battery control system may include that the driving circuit in the battery control system detects whether the processor in the battery control system is abnormal. The driving circuit may be configured to control the switch of the power supply circuit connected to the battery.

Optionally, the driving circuit 27 in the battery control system 22 may detect whether the processor 26 is abnormal.

At step S702, the switch of the power supply circuit connected to the battery may be controlled according to the status information of the processor. The battery may be configured to supply power to a movable platform.

For example, the driving circuit 27 may control the switch 25 of the power supply circuit 24 connected to the battery 21 according to the status information of the processor 26. The battery 21 may be configured to supply power the movable platform. Optionally, the movable platform may include the unmanned aerial vehicle.

Controlling the switch of the power supply circuit connected to the battery according to the status information of the processor may include that if the processor is in the abnormal status, the driving circuit may control the switch of the power supply circuit connected to the battery to be connected, such that the power supply circuit may continue supplying power to the movable platform.

For example, when the driving circuit 27 determines that the processor 26 is in the abnormal status, the driving circuit 27 may control the switch 25 of the power supply circuit 24 connected to the battery 21 to be connected, such that the power supply circuit 24 may continue supplying power to the unmanned aerial vehicle 20.

Detecting whether the processor in the battery control system is abnormal by the driving circuit in the battery control system may include detecting whether the processor in the battery control system is in the reset status by the driving circuit in the battery control system.

For example, the driving circuit 27 in the battery control system 22 may detect whether the processor 26 is in the reset status.

If the processor is in the abnormal status, the driving circuit may control the switch of the power supply circuit connected to the battery to be connected, thereby continuously supplying power to the movable platform by the power supply circuit, which may include that if the processor is in the reset status, the driving circuit may control the switch of the power supply circuit connected to the battery to be connected, thereby continuously supplying power to the movable platform by the power supply circuit.

For example, when the driving circuit 27 determines that the processor 26 is in the reset status, the driving circuit 27 may control the switch 25 of the power supply circuit 24 connected to the battery 21 to be connected. Therefore, the power supply circuit 24 may continue supplying power to the unmanned aerial vehicle 20, which may avoid that the unmanned aerial vehicle 20 in the flight status is forced to crash because the battery 21 may immediately stop supplying power to the unmanned aerial vehicle 20 when the reset of the processor 26 is interfered. In other embodiments, when the reset of the processor 26 is interfered, the flight controller 23 may not be able to communicate normally with the processor 26. At this point, the flight controller 23 may control the unmanned aerial vehicle 20 to descend to avoid crash.

Furthermore, controlling the switch of the power supply circuit connected to the battery according to the status information of the processor may include that when the processor is in the upgrade status and the current of the battery is greater than or equal to a current threshold, the switch of the power supply circuit connected to the battery may be controlled to be disconnected, such that the power supply circuit may stop supplying power.

The processor 26 may further detect other status information. For example, the processor 26 may further detect whether the processor is in the upgrade status. If the processor 26 is in the upgrade status, the upgrade loader may also detect the voltage and/or current of the battery 21. Furthermore, the processor 26 may also control the switch 25 of the power supply circuit 24 connected to the battery 21 according to the voltage and/or current of the battery 21.

For example, when the processor 26 is in the upgrade status and the current of the battery 21 is greater than or equal to the current threshold, the switch 25 of the power supply circuit 24 connected to the battery 21 may be controlled to be disconnected by the processor 26, such that the power supply circuit may stop supplying power and the battery 21 may be avoided to be damaged due to overcurrent.

Moreover, controlling the switch of the power supply circuit connected to the battery according to the status information of the processor may include that when the processor is in the upgrade status and the voltage of the battery is less than or equal to the first voltage threshold, the switch of the power supply circuit connected to the battery may be controlled to be disconnected, such that the power supply circuit may stop supplying power.

For example, when the processor 26 is in the upgrade status and the voltage of the battery 21 is less than or equal to the first voltage threshold (i.e., undervoltage), the switch 25 of the power supply circuit 24 connected to the battery 21 may be controlled to be disconnected, such that the power supply circuit 24 may stop supplying power and the battery 21 may be avoided to be damaged due to undervoltage. Optionally, the first voltage threshold is 3.2 V.

In one embodiment, by detecting the status information of the processor in the battery control system, the switch of the power supply circuit connected to the battery may be controlled according to the status information of the processor, which may avoid that the unmanned aerial vehicle in the flight status is forced to crash because the battery may immediately stop supplying power to the unmanned aerial vehicle when the reset of the processor is interfered. Moreover, when the processor is in the upgrade status and the battery is in the undervoltage or overcurrent status, the switch of the power supply circuit connected to the battery may be controlled to be disconnected. Therefore, the power supply circuit may stop supplying power to prevent the battery from being damaged due to undervoltage or overcurrent, and on the basis of ensuring the safe flight of the unmanned aerial vehicle, the battery may be avoided to be damaged.

The embodiments of the present disclosure provide a battery control system. FIG. 8 illustrates a structural schematic of a battery control system according to exemplary embodiments of the present disclosure. As shown in FIG. 8, a battery control system 80 may include one or more processors 81. The processor 81 may be configured to acquire the status information of the unmanned aerial vehicle and the electrical parameter information of the battery, where the battery is configured to supply power to the unmanned aerial vehicle; the processor 81 may further be configured to determine whether the battery is abnormal according to the electrical parameter information of the battery; and the processor 81 may further be configured to, when the status information of the unmanned aerial vehicle indicates that the unmanned aerial vehicle is in the flight status and the battery is in the abnormal status, to control the battery to continue supplying power to the unmanned aerial vehicle.

Optionally, the electrical parameter information of the battery may include at least one of the following: a voltage, a current, an output power, a remaining power, or a temperature of the battery.

Optionally, when the processor 81 determines whether the battery is abnormal according to the electrical parameter information of the battery, the processor 81 may be configured to determine whether the battery is in the undervoltage status according to the voltage of the battery; and when the status information of the unmanned aerial vehicle indicates that the unmanned aerial vehicle is in the flight status and the battery is in the abnormal status, the processor 81 may be configured to control battery to continue supplying power to the unmanned aerial vehicle.

Optionally, when the processor 81 controls battery to continue supplying power to the unmanned aerial vehicle, the processor 81 may be configured to control the power supply circuit connected to the battery to supply power to the unmanned aerial vehicle.

Optionally, when the processor 81 controls the power supply circuit connected to the battery to continue supplying power to the unmanned aerial vehicle, the processor 81 may be configured to control the switch of the power supply circuit connected to the battery to be connected, thereby continuously supplying power to the unmanned aerial vehicle by the power supply circuit.

Optionally, when the status information of the unmanned aerial vehicle indicates that the unmanned aerial vehicle is in the non-flight status and the battery is in the abnormal status, the processor 81 may be further configured to control the battery to stop supplying power to the unmanned aerial vehicle.

Optionally, when the status information of the unmanned aerial vehicle indicates that the unmanned aerial vehicle is in the non-flight status and the battery is in the undervoltage status, the processor 81 may be configured to control the battery to stop supplying power to the unmanned aerial vehicle.

Optionally, when the processor 81 controls the battery to stop supplying power to the unmanned aerial vehicle, the processor 81 may be configured to control the power supply circuit connected to the battery to stop supplying power to the unmanned aerial vehicle.

Optionally, when the processor 81 controls the power supply circuit connected to the battery to stop supplying power to the unmanned aerial vehicle, the processor 81 may be configured to control the switch of the power supply circuit connected to the battery to be disconnected, such that the power supply circuit may stop supplying power to the unmanned aerial vehicle.

Optionally, when the processor 81 acquires the status information of the unmanned aerial vehicle, the processor 81 may be configured to receive the status information of the unmanned aerial vehicle transmitted by the flight controller of the unmanned aerial vehicle.

Optionally, the battery control system 80 may further include a driving circuit 82 which is electrically connected to the processor 81. The driving circuit 82 may be configured to detect the status information of the processor in the battery control system and control the switch of the power supply circuit connected to the battery according to the status information of the processor 81.

Optionally, when the driving circuit 82 detects the status information of the processor in the battery control system, the driving circuit 82 may be configured to detect whether the processor in the battery control system is abnormal. When the driving circuit 82 controls the switch of the power supply circuit connected to the battery according to the status information of the processor 81, the driving circuit 82 may be configured to, if the processor 81 is in the abnormal status, control the switch of the power supply circuit connected to the battery to be connected, such that the power supply circuit may continue supplying power to the unmanned aerial vehicle.

Optionally, when the driving circuit 82 detects whether the processor in the battery control system is abnormal, the driving circuit 82 may be configured to detect whether the processor in the battery control system is in the reset status. If the processor 81 is in the reset status, the driving circuit 82 may control the switch of the power supply circuit connected to the battery to be connected, thereby continuously supplying power to the unmanned aerial vehicle by the power supply circuit.

Optionally, the processor 81 may also be configured to detect the status information of the processor 81 and control the switch of the power supply circuit connected to the battery according to the status information of the processor 81.

Optionally, when controlling the switch of the power supply circuit connected to the battery according to the status information of the processor 81, the processor 81 may be configured to, when the processor 81 is in the upgrade status and the current of the battery is greater than or equal to the current threshold, control the switch of the power supply circuit connected to the battery to be disconnected, such that the power supply circuit may stop supplying power.

Optionally, when controlling the switch of the power supply circuit connected to the battery according to the status information of the processor 81, the processor 81 may be configured to, when the processor 81 is in the upgrade status and the voltage of the battery is less than or equal to the first voltage threshold, control the switch of the power supply circuit connected to the battery to be disconnected, such that the power supply circuit may stop supplying power.

Optionally, the processor 81 may further be configured to detect the status information of the battery; and when the battery is in the charging status and the voltage of the battery is greater than or equal to the second voltage threshold, the processor 81 may further be configured to control the switch of the power supply circuit connected to the battery to be connected, such that the power supply circuit may supply power to outside.

Optionally, the processor 81 may further be configured to, when the battery is in the charging status and the voltage of the battery is greater than or equal to the third voltage threshold, control the switch of the power supply circuit connected to the battery to be disconnected, such that the power supply circuit may stop supplying power to the battery.

Optionally, the processor 81 may include the micro controller unit (MCU).

The principle and implementation of the battery control system provided in the embodiments of the present disclosure may be similar to the embodiments shown in FIG. 1, FIG. 4, or FIG. 6, which may not be described in detail herein.

In one embodiment, the status information of the unmanned aerial vehicle and the electrical parameter information of the battery may be acquired through the battery control system, and whether the battery is abnormal is determined according to the electrical parameter information of the battery. When the unmanned aerial vehicle is in the flight status and the battery is in the abnormal status, the battery control system may control the battery to continue supplying power to the unmanned aerial vehicle, thereby preventing the unmanned aerial vehicle from crashing due to battery interruption during the flight process to ensure the safety of the unmanned aerial vehicle.

The embodiments of the present disclosure provide the battery control system. As shown in FIG. 8, the battery control system 80 may include one or more processors 81. The processor 81 may be configured to detect the status information of the processor 81 and control the switch of the power supply circuit connected to the battery according to the status information of the processor 81. The battery may be configured to supply power to the movable platform.

Optionally, when controlling the switch of the power supply circuit connected to the battery according to the status information of the processor 81, the processor 81 may be configured to, when the processor 81 is in the upgrade status and the current of the battery is greater than or equal to the current threshold, control the switch of the power supply circuit connected to the battery to be disconnected, such that the power supply circuit may stop supplying power.

Optionally, when controlling the switch of the power supply circuit connected to the battery according to the status information of the processor 81, the processor 81 may be configured to, when the processor is in the upgrade status and the voltage of the battery is less than or equal to the first voltage threshold, control the switch of the power supply circuit connected to the battery to be disconnected, such that the power supply circuit may stop supplying power.

Optionally, the movable platform may include the unmanned aerial vehicle.

The principle and implementation of the battery control system provided in the embodiments of the present disclosure may be similar to the embodiments shown in FIG. 7, which may not be described in detail herein.

In one embodiment, by detecting the status information of the processor in the battery control system, the switch of the power supply circuit connected to the battery may be controlled according to the status information of the processor, which may avoid that the unmanned aerial vehicle in the flight status is forced to crash because the battery may immediately stop supplying power to the unmanned aerial vehicle when the reset of the processor is interfered. Moreover, when the processor is in the upgrade status and the battery is in the undervoltage or overcurrent status, the switch of the power supply circuit connected to the battery may be controlled to be disconnected. Therefore, the power supply circuit may stop supplying power to prevent the battery from being damaged due to undervoltage or overcurrent, and on the basis of ensuring the safe flight of the unmanned aerial vehicle, the battery may be avoided to be damaged.

The embodiments of the present disclosure provide the battery control system. As shown in FIG. 8, the battery control system 80 may include one or more processors 81 and driving circuits 82 which are electrically connected with each other. The driving circuit 82 may be configured to control the switch of the power supply circuit connected to the battery, where the battery is configured to supply power to the movable platform. The processor 81 may be configured to control the switch through the driving circuit 82. The driving circuit 82 may be configured to detect the status information of the processor in the battery control system and control the switch of the power supply circuit connected to the battery according to the status information of the processor 81.

Optionally, when detecting the status information of the processor in the battery control system, the driving circuit 82 may be configured to detect whether the processor in the battery control system is abnormal. When controlling the switch of the power supply circuit connected to the battery according to the status information of the processor 81, the driving circuit 82 may be configured to, if the processor 81 is in the abnormal status, control the switch of the power supply circuit connected to the battery to be connected, such that the power supply circuit may continue supplying power to the movable platform.

Optionally, when detecting whether the processor in the battery control system is abnormal, the driving circuit 82 may be configured to detect whether the processor in the battery control system is in the reset status; if the processor is in the reset status, the driving circuit 82 may be configured to control the switch of the power supply circuit connected to the battery to be connected, such that the power supply circuit may continue supplying power to the movable platform.

Optionally, the movable platform may include the unmanned aerial vehicle.

The principle and implementation of the battery control system provided in the embodiments of the present disclosure may be similar to the embodiments shown in FIG. 7, which may not be described in detail herein.

In one embodiment, by detecting the status information of the processor in the battery control system, the switch of the power supply circuit connected to the battery may be controlled according to the status information of the processor, which may avoid that the unmanned aerial vehicle in the flight status is forced to crash because the battery may immediately stop supplying power to the unmanned aerial vehicle when the reset of the processor is interfered. Moreover, when the processor is in the upgrade status and the battery is in the undervoltage or overcurrent status, the switch of the power supply circuit connected to the battery may be controlled to be disconnected. Therefore, the power supply circuit may stop supplying power to prevent the battery from being damaged due to undervoltage or overcurrent, and on the basis of ensuring the safe flight of the unmanned aerial vehicle, the battery may be avoided to be damaged.

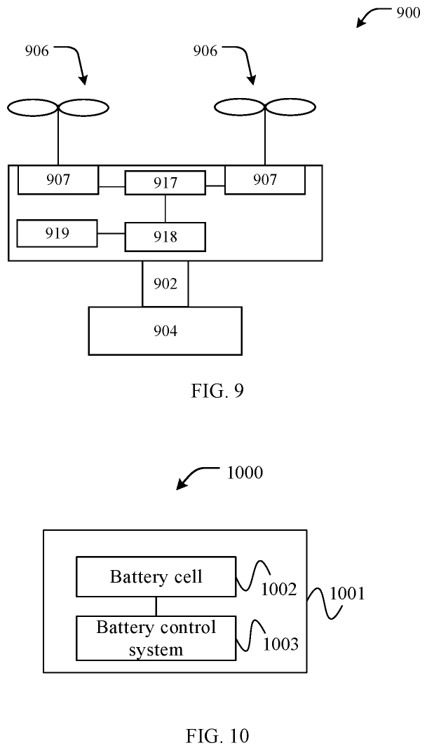

The embodiments of the present disclosure provide the unmanned aerial vehicle. FIG. 9 illustrates a structural schematic of an unmanned aerial vehicle according to exemplary embodiments of the present disclosure. As shown in FIG. 9, an unmanned aerial vehicle 900 may include an aircraft body, a power system, a flight controller 918, and a battery control system 919. The power system may include one of the following: a motor 907, propellers 906, and an electric governor 917. The power system may be disposed on the aircraft body to supply flight power. The flight controller 918 may be connected to the power system through communication to control the flight of the unmanned aerial vehicle.

The principle and the implementation of the battery control system 919 may be similar to the above-mentioned embodiments, which may not be described in detail herein.

Moreover, as shown in FIG. 9, the unmanned aerial vehicle 900 may further include a support device 902 and a photographing device 904, where the support device 902 may be a gimbal.

In one embodiment, the status information of the unmanned aerial vehicle and the electrical parameter information of the battery may be acquired through the battery control system, and whether the battery is abnormal is determined according to the electrical parameter information of the battery. When the unmanned aerial vehicle is in the flight status and the battery is in the abnormal status, the battery control system may control the battery to continue supplying power to the unmanned aerial vehicle, thereby preventing the unmanned aerial vehicle from falling due to battery interruption during the flight process to ensure the safety of the unmanned aerial vehicle.

The embodiments of the present disclosure provide a battery. FIG. 10 illustrates a structural schematic of the battery according to exemplary embodiments of the present disclosure. As shown in FIG. 10, a battery 1000 may include a housing 1001, a battery cell 1002, and a battery control system 1003. The battery cell 1002 may be installed in the housing 1001, the battery control system 1003 may be installed in the housing 1001, and the battery control system 1003 may be electrically connected to the battery cell 1002. The principle and the implementation of the battery control system 1003 may be similar to the above-mentioned embodiments, which may not be described in detail herein.

In one embodiment, the status information of the unmanned aerial vehicle and the electrical parameter information of the battery may be acquired through the battery control system, and whether the battery is abnormal is determined according to the electrical parameter information of the battery. When the unmanned aerial vehicle is in the flight status and the battery is in the abnormal status, the battery control system may control the battery to continue supplying power to the unmanned aerial vehicle, thereby preventing the unmanned aerial vehicle from crashing due to battery interruption during the flight process to ensure the safety of the unmanned aerial vehicle.

In some embodiments provided by the present disclosure, it should be understood that the disclosed systems, devices, and methods may be implemented in other manners. For example, the device embodiments described above are merely illustrative. For example, the division of the unit is only a logical function division. In actual implementations, there may be other division manners. For example, multiple units or components may be combined or may be integrated into another system, or some features may be ignored or not executed. In addition, the mutual coupling, direct coupling or communication connection shown or discussed in the above-mentioned embodiments may be the indirect coupling or communication connection through certain interfaces, devices or units, and may be in electrical, mechanical or other forms.

The units described as separate components may or may not be physically separated, and the components displayed as units may or may not be physical units, that is, may be located in one location, or may be distributed to multiple network units. Certain or all of the units may be selected according to actual needs to achieve the purpose of the solution of the embodiments.

In addition, each functional unit in each embodiment of the present disclosure may be integrated into one processor, or each unit may be physically separated, or two or more units may be integrated into one unit. The above-mentioned integrated unit may be implemented in the form of hardware and may also be implemented in the form of hardware and software.

The above-mentioned integrated unit implemented in the form of the software functional unit may be stored in a computer-readable storage medium. The above-mentioned software functional unit may be stored in a storage medium and include a plurality of instructions for enabling a computer device (which may be a personal computer, a server, or a network device) or a processor to execute certain steps of the methods described in the embodiments of the present disclosure. The above-mentioned storage media may include U disks, mobile hard disks, read-only memory (ROM), random access memory (RAM), magnetic disks, compact discs, and other various media that can store program code.

Those skilled in the art may clearly understand that for the convenience and brevity of the description, the above-mentioned division of the functional modules may be merely used as an example. In practical applications, the above-mentioned functions may be allocated by different functional modules according to requirements. That is, the internal structure may be divided into different functional modules to complete all or part of the functions described above. For the specific working process of the device described above, reference may be made to the corresponding process in the above-mentioned method embodiments, which may not be described in detail herein.

It should be finally noted that the above-mentioned embodiments may be merely used to illustrate the technical solutions of the present disclosure but may not be intended to limit the technical solutions. Although the present disclosure has been described in detail with reference to the above-mentioned embodiments, those skilled in the art should understand that the technical solutions described in the above-mentioned embodiments may be modified, or certain or all of the technical features may be equivalently replaced; and these modifications or replacements may not leave the essence of the corresponding technical solutions outside the scope of the technical solutions of the embodiments of the present disclosure.

What is claimed is:

1. A battery control method, applied to a battery control system, the method comprising:
acquiring status information of an unmanned aerial vehicle and electrical parameter information of a battery, wherein the battery is configured to supply power to the unmanned aerial vehicle;
determining whether the battery is abnormal according to the electrical parameter information of the battery; and
when the status information of the unmanned aerial vehicle indicates that the unmanned aerial vehicle is in a flight status and the battery is in an abnormal status, controlling the battery to continue supplying the power to the unmanned aerial vehicle.

2. The method according to claim 1, wherein:
the electrical parameter information of the battery includes at least one of a voltage, a current, an output power, a remaining power, or a temperature of the battery.

3. The method according to claim 2, wherein:
determining whether the battery is abnormal according to the electrical parameter information of the battery includes:
determining whether the battery is undervoltage according to the voltage of the battery; and
when the status information of the unmanned aerial vehicle indicates that the unmanned aerial vehicle is in the flight status and the battery is in the abnormal status, controlling the battery to continue supplying the power to the unmanned aerial vehicle includes:
when the status information of the unmanned aerial vehicle indicates that the unmanned aerial vehicle is in the flight status and the battery is undervoltage, controlling the battery to continue supplying the power to the unmanned aerial vehicle.

4. The method according to claim 1, wherein controlling the battery to continue supplying the power to the unmanned aerial vehicle includes:
controlling a power supply circuit connected to the battery to continue supplying the power to the unmanned aerial vehicle.

5. The method according to claim 4, wherein controlling the power supply circuit connected to the battery to continue supplying the power to the unmanned aerial vehicle includes:
controlling a switch of the power supply circuit connected to the battery to be connected, such that the power supply circuit continues supplying the power to the unmanned aerial vehicle.

6. The method according to claim 1, further including:
when the status information of the unmanned aerial vehicle indicates that the unmanned aerial vehicle is in a non-flight status and the battery is in the abnormal status, controlling the battery to stop supplying the power to the unmanned aerial vehicle.

7. The method according to claim 6, wherein controlling the battery to stop supplying the power to the unmanned aerial vehicle includes:
when the status information of the unmanned aerial vehicle indicates that the unmanned aerial vehicle is in the non-flight status and the battery is undervoltage, controlling the battery to stop supplying the power to the unmanned aerial vehicle.

8. The method according to claim 6, wherein controlling the battery to stop supplying the power to the unmanned aerial vehicle includes:
controlling a power supply circuit connected to the battery to stop supplying the power to the unmanned aerial vehicle.

9. The method according to claim 8, wherein controlling the power supply circuit connected to the battery to stop supplying the power to the unmanned aerial vehicle includes:
controlling a switch of the power supply circuit connected to the battery to be disconnected, such that the power supply circuit stops supplying the power to the unmanned aerial vehicle.

10. The method according to claim 1, wherein acquiring the status information of the unmanned aerial vehicle includes:
receiving the status information of the unmanned aerial vehicle transmitted by a flight controller of the unmanned aerial vehicle.

11. The method according to claim 1, further including:
detecting status information of a processor in the battery control system; and
controlling a switch of a power supply circuit connected to the battery according to the status information of the processor.

12. The method according to claim 11, wherein:
detecting the status information of the processor in the battery control system includes:
detecting whether the processor in the battery control system is abnormal by a driving circuit in the battery control system, wherein the driving circuit is configured to control the switch of the power supply circuit connected to the battery; and
controlling the switch of the power supply circuit connected to the battery according to the status information of the processor includes:
if the processor is in an abnormal status, controlling the switch of the power supply circuit connected to the battery to be connected by the driving circuit, such that the power supply circuit continues supplying the power to the unmanned aerial vehicle.

13. The method according to claim 12, wherein:
detecting whether the processor in the battery control system is abnormal by the driving circuit in the battery control system includes:
detecting whether the processor in the battery control system is in a reset status by the driving circuit in the battery control system; and
if the processor is in the abnormal status, controlling the switch of the power supply circuit connected to the battery to be connected by the driving circuit, such that the power supply circuit continues supplying the power to the unmanned aerial vehicle, includes:
if the processor is in the reset status, controlling the switch of the power supply circuit connected to the battery to be connected by the driving circuit, such that the power supply circuit continues supplying the power to the unmanned aerial vehicle.

14. The method according to claim 11, wherein controlling the switch of the power supply circuit connected to the battery according to the status information of the processor includes:
when the processor is in an upgrade status and a current of the battery is greater than or equal to a current threshold, controlling the switch of the power supply circuit connected to the battery to be disconnected, such that the power supply circuit stops supplying the power.

15. The method according to claim 11, wherein controlling the switch of the power supply circuit connected to the battery according to the status information of the processor includes:
when the processor is in an upgrade status and a voltage of the battery is less than or equal to a first voltage threshold, controlling the switch of the power supply circuit connected to the battery to be disconnected, such that the power supply circuit stops supplying the power.

16. The method according to claim 1, further including:
detecting status information of the battery; and
when the battery is in a charging status and a voltage of the battery is greater than or equal to a second voltage threshold, controlling the switch of the power supply circuit connected to the battery to be connected, such that the power supply circuit supplies power for outside.

17. The method according to claim 16, further including:
when the battery is in the charging status and the voltage of the battery is greater than or equal to a third voltage threshold, controlling the switch of the power supply circuit connected to the battery to be disconnected, such that the power supply circuit stops supplying power to the battery.

18. The method according to claim 11, wherein:
the processor includes a micro controller unit (MCU).

19. A battery control method, applied to a battery control system, the method comprising:
detecting status information of a processor in the battery control system; and
controlling a switch of a power supply circuit connected to a battery according to the status information of the processor, wherein the battery is configured to supply power to a movable platform.

20. The method according to claim 19, wherein:
detecting the status information of the processor in the battery control system includes:
detecting whether the processor in the battery control system is abnormal by a driving circuit in the battery control system, wherein the driving circuit is configured to control the switch of the power supply circuit connected to the battery; and
controlling the switch of the power supply circuit connected to the battery according to the status information of the processor includes:
if the processor is in an abnormal status, controlling the switch of the power supply circuit connected to the battery to be connected by the driving circuit, such that the power supply circuit continues supplying the power to the movable platform.
